(19) United States
(12) Patent Application Publication
(10) Pub. No.: US 2023/0284646 A1
(43) Pub. Date: Sep. 14, 2023

(54) COFFEA SEED PROCESSING METHODS AND PRODUCTS

(71) Applicant: The Sprouted Brain LLC, Wilmington, DE (US)

(72) Inventors: Dennis Barker, Ontario (CA); David Kanaya, Ontario (CA)

(21) Appl. No.: 18/180,032

(22) Filed: Mar. 7, 2023

Related U.S. Application Data
(60) Provisional application No. 63/268,971, filed on Mar. 7, 2022.

(51) Int. Cl. A23F 5/02; C02F 1/00; C02F 1/32

(52) U.S. Cl. CPC A23F 5/02; C02F 1/001; C02F 1/32; C02F 2103/32

(57) ABSTRACT

Novel processes, systems, compositions, and methods for the treatment of green coffee beans after harvest.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

The preparation of coffee and coffee related products requires the harvesting and processing of coffea seeds (more commonly known as coffee beans). Coffee beans can be ingested, brewed, or otherwise further processed into downstream products. When coffee beans are brewed, the resulting coffee beverage can contain over 1,000 phytochemicals, which determine among other factors, taste, aroma, and nutritional content. The treatment of certain crop products following harvest may affect their final quality, including, but not limited to, coffee beans. Coffee is a complex food stuff with more than one thousand phytochemicals responsible for various taste, aroma, and health-promoting characteristics. Research suggests many of these compounds provide therapeutic effect, through anti-inflammatory, antifibrotic, anticancer and other properties. Related teachings include coffee variety, origin, and extraction procedure: Implications for coffee beneficial effects on human health. Food Chem. 2019, 278, 47-55. Pub Med; The Beneficial Effects of Coffee in Human Nutrition. Biol. Med. 2015, 7, 240:1-240:5; A Decade of Research on Coffee as an Anticarcinogenic Beverage, the teachings of which are consistent with the embodiments and examples shown and described herein are incorporated by reference in their entireties.

During traditional coffee bean processing for use in coffee beverages, coffee seeds are generally removed from a coffee fruit (a coffee cherry), de-skinned/de-pulped, and dehydrated prior to roasting. Surprisingly, Applicant has discovered numerous benefits that can be imparted on coffee beans and resulting products through germination and related processes. Applicants therefore provide in this Application methods, processes, products, and systems for the treatment of harvested crops, including coffee beans, without the drawbacks presented by the traditional systems and methods and/or that improve the outcomes over traditional systems and methods.

### SUMMARY

The present disclosure relates to methods, systems, and compositions related to processing coffee beans after harvest. It will be understood that the process and method details herein are for the purposes of describing embodiments of the disclosure and are not intended to limit the disclosure or any invention thereto. Further, it will be understood that all steps presented herein can be processed serially, individually, in combination with one another, or in any order. Products formed by the processed coffea seeds described herein have surprisingly improved organoleptic characteristics relating to taste and aroma, in addition to possible increased bioavailability and decreased amounts of undesirable phytochemical species. In particular, organoleptic qualities can include fragrance, aroma, flavor, bitterness, sweetness, saltness, acidity, mouth feel, aftertaste, cup balance, astringency, texture, or a combination of the foregoing. Advantageously, the methods and compositions disclosed herein do not suffer from certain complications that may exist within the prior art. In some cases, regulatory unapproved or foreign adjuncts are added to compositions in order to process coffee beans. Unapproved adjuncts can include those from xenogenic sources like chitosan, or adjuncts which are otherwise not approved under regulatory rules for the processing of coffee seeds.

In some embodiments, processes of the inventions include penetrating a predetermined volume of coffee beans with a plurality of hydration, activation, and dehydration cycles to yield an improved coffee bean population for roasting and subsequent coffee drinks. Additionally, in some embodiments, the processes may further include roasting and grinding steps, either performed separately or as part of a single unit operation.

In one embodiment, a method of short-term germination of a coffee bean species comprises exposing a predetermined volume of coffee beans to a plurality of hydration, activation, and dehydration cycles to yield a short-term germinated coffee bean population having a reduction of anti-nutritive compounds while improving organoleptic properties, and wherein each individual hydration cycle comprises a time period less than the time required for conventional hydration for complete germination of the coffee bean species.

The products of the disclosed processes (“processed beans”) may then be further used in a variety of applications, including the preparation of coffee based beverages. It will be understood that the processed beans may be used after germination, but before roasting, or after roasting but before grinding, or after grinding. It may be appreciated that the processed beans prior to roasting, and prior to grinding, may possess handling and physical characteristics dissimilar to traditionally prepared coffee beans, including moisture retention, moisture evaporation, moisture

Moreover, coffee seed germination can be characterized by a series of progressive stages, culminating in germination of a seed and preparation for further plant development. In stage 1, or pre-germination, endosperm cells imbibe water across the cellular membrane. Due to increased water uptake, the suspensor will emerge from individual seeds, which assists in pushing the endosperm into a nascent plant embryo. Next, in stage 2, the beginning of the germination process, turgid seeds and constituent cells begin to metabolize stored nutrients, to feed the plant embryo. Lastly, stage 3 comprises the emergence of a radicle from the endosperm, which is the embryonic root of the plant, thereby elongating the embryonic axis. While the stages of each phase are determined by ambient conditions, including environmental water content, soil or medium characteristics, or the relative condition of each seed, the present disclosure relates to germination initiation, wherein nutrients within the seed are metabolically processed in order to feed a plant embryo.

It will be appreciated that even under optimal conditions, stage 2 of germination, wherein cells within a seed begin to metabolize nutrients, occurs after about 10 hours, after about 11 hours, after about 12 hours, after about 13 hours, after about 14 hours, after about 15 hours, after about 16 hours, after about 17 hours, after about 18 hours, after about 19 hours, or after about 20 hours. Alternatively, stage 2 of germination occurs after seeds have been hydrated sufficiently, drained, positioned, and left to metabolically activate for after a period of about 16 hours or until an exothermic reaction is evident one skilled in the art.

Further, from the art, it can be appreciated that traditionally, inherent increases on certain chemical species, including caffeine, were expected as a result of the germination process. One teaching, provides that caffeine continues to increase as much as 122% compared to pre-germinated seeds during the first five days of germination. “Changes of the chlorogenic acid, caffeine, gama-aminobutyric acid (GABA) and antioxdant activities during germination of coffee bean (Coffea arabica).” Emirates Journal of Food and Agriculture (2018): 675-680. Surprisingly, it was found that germination processes as described herein in fact decrease overall caffeine levels compared to pre-germinated seeds.

In one embodiment, a method of preparing coffee beans for roasting comprises providing a plurality of coffee beans in a substantially water impermeable container; adding a discrete hydration medium to the container; germinating the beans at a temperature of about 29° C. to about 31° C. for substantially two hours; discharging the medium and aerating the beans; subsequently adding a discrete second hydration medium to the container; germinating the beans at a temperature of about 29° C. to about 31° C. for 20 substantially two hours; and subsequently discharging the medium and aerating the beans, and wherein the method consisting essentially of providing at least two discrete hydration cycles followed by a determined activation cycle, including any activation step/element shown and described herein, and dehydration cycle, including any dehydration step/element shown and described herein.

In one embodiment, a coffee bean treatment comprises hydrating coffee beans, providing an activation phase, including any activation step/element shown and described herein, after hydrating the beans, for instance prior to a substantial exothermic reaction; physically manipulating the beans; and providing single-direction, positive airflow ventilation about the beans, for instance at any amount and duration wherein the resulting coffee beans have improved organoleptic characteristics and/or are a ready-to-roast population.

In one embodiment, a coffee bean treatment comprises penetrating the bean with a plurality of discrete mediums to substantially hydrate the beans for activating metabolism; and aerating the beans between the discrete medium penetrations, providing an activation phase, including any activation step/element shown and described herein, and wherein the resulting coffee beans germinated under controlled environmental conditions comprise a reduced anti-nutritive yield compared to a control bean.

In one embodiment, a short-term germinated green coffee bean comprises an improved organoleptic characteristic treated by any of the methods herein.

In one embodiment, a short-term germinated green coffee bean comprises a reduced antinutrient characteristic treated by any of the methods herein.

In one embodiment, a coffee liquid comprises roasting products of a coffee bean population, wherein the coffee bean population comprises improved organoleptic characteristics derived from any of the methods herein.

In one embodiment, a coffee liquid comprises roasting products of a coffee bean population, wherein the coffee bean population comprises reduced antinutrient characteristics derived from any of the methods herein.

In one embodiment, a coffee liquid comprises roasting products of a coffee bean population, wherein the coffee bean population comprises reduced caffeine content derived from any of the methods herein.

In one embodiment, a treatment of green coffee beans for roasting after harvest comprises providing a predetermined volume of green coffee beans in a germination chamber; immersing the beans in the germination chamber with a liquid bath to define a first-hydrated medium; draining the first-hydrated medium and aerating the beans to define a first-hydrated bean population; immersing the first-hydrated bean population in the germination chamber with a liquid bath to define a second-hydrated medium; draining the second-hydrated medium and aerating the beans to define a second-hydrated bean population; immersing the second-hydrated bean population in the germination chamber with a liquid bath to define a third-hydrated medium; draining the third-hydrated medium and aerating the beans to define a third-hydrated bean population; and decanting the third-hydrated bean population to a layer of substantially uniform thickness, providing a hold activation phase after hydrating the bean, for instance prior to a substantial exothermic reaction, physically removing the beans, and removing bean moisture through dehydration to an internal residual moisture content associated with a species, including but not limited to, between about 10% to about 12% moisture content by weight.

In certain examples the coffee beans absorb the first-hydrated medium to a range of about 28% to about 45% moisture content by weight. In certain examples a Sumatran Mandehling coffee bean absorbs the first-hydrated medium to a range of about 29% to about 33% moisture content by weight. In certain examples a Costa Rican coffee bean absorbs the first-hydrated medium to a range of about 37% to about 41% moisture content by weight. In certain examples a Brazilian coffee bean absorbs the first-hydrated medium to a range of about 40% to about 42% moisture content by weight.

In certain examples a Sumatran Mandehling coffee bean absorbs the second-hydrated medium to a range of about 39% to about 41% moisture content by weight. In certain examples a Costa Rican coffee bean absorbs the second-hydrated medium to a range of about 46% to about 48% moisture content by weight. In certain examples a Brazilian coffee bean absorbs the second-hydrated medium to a range of about 48% to about 52% moisture content by weight.

In certain examples a Sumatran Mandehling coffee bean absorbs the third-hydrated medium to a range of about 40% to about 50% moisture content by weight. In certain examples a Costa Rican coffee bean absorbs the third-hydrated medium to a range of about 49% to about 50% moisture content by weight. In certain examples a Brazilian coffee bean absorbs the third-hydrated medium to a range of about 50% to about 53% moisture content by weight.

In certain examples immersing the beans in the liquid bath comprises immersion in a water bath. The method may include passing the water bath through a filter to remove particulate contaminants. The method may include a filter comprising a charcoal or other filter. The method may include treating the water bath with an ultraviolet light treatment. The method may include selecting a green coffee bean removed from a cherry and having a uniform density. The method may include maintaining an environmental temperature of about 25° C. to about 35° C. The method may include maintaining an environmental temperature of about 29° C. to about 32° C.

In certain examples, the method may include activating a plurality of thermostatic mixing valves adapted to maintain a constant outlet temperature into the germination chamber. The method may include monitoring temperature deviations. The method may include sensing and correcting temperature deviations. The method may include maintaining an environmental humidity of less than about 75% humidity. The method may include maintaining an environmental humidity of between about 40% to about 60% humidity. The method may include sensing and correcting environmental humidity. The method may include providing a negative air pressure germination environment. The method may include filtering a selection of fine particulates, airborne contaminants, and the like. The method may include treating the air with an ultraviolet light treatment.

In certain examples, the method may include decanting the predetermined volume of green coffee beans into a germination chamber. The method may include monitoring liquid bath absorption rates. The method may include varying liquid bath absorption rates adapted for specific bean species. The method may include monitoring absorption rates via a halogen moisture analyzer. The method may include circulating oxygen about the germination chamber. The method may include agitating the beans. The method may include agitating the beans at a rate between about five to about twenty-five rotations per minute, or the like. The method may include agitating the beans for a time period between about two minutes to about five minutes, or the like.

In certain examples, decanting to the substantially uniform thickness may include transferring the third-hydrated bean population to a growing tray. The method may include aligning the third-hydrated bean population to a predetermined thickness associated with a variant-specific drying modality. In particular examples, the method may include aligning the third-hydrated bean population to a predetermined thickness between about three inches to about eight inches adapted for a respire environment. The method may include aligning the third-hydrated bean population to a thickness of about six inches adapted for a respire environment. The method may include maintaining a minimum thickness adapted for a predetermined exothermic energy release environment. The predetermined exothermic energy release environment may be achieved when a core temperature of the bean reaches about a one-hundred-degree Fahrenheit temperature. In particular examples, the one-hundred-degree Fahrenheit temperature may trigger an energy release, including but not limited to, chemical changes indicative of phase two of bean germination as recognized by those skilled in the art having the benefit of this disclosure. Further, the slowing of the germination may be subsequently triggered through any of the dehydration steps shown and described herein.

In certain examples, the method may include dehydrating at a dehydration temperature of about 120° Fahrenheit to about 140° Fahrenheit. The method may include dehydrating at a dehydration temperature of about 125° Fahrenheit to about 135° Fahrenheit. The method may include dehydrating for a period of about four hours to about eight hours. The method may include dehydrating for a period of about five hours to about six hours. The method may include providing a single-direction, positive airflow ventilation about the beans. The method may include airflow of about 2.000 cubic feet per minute to about 40.000 cubic feet per minute. The method may include airflow of about 3.000 cubic feet per minute. The method may include agitating the beans. The method may include periodically agitating the beans between about two to about four-hour intervals. The method may include applying an effective amount of a composition in any of the steps shown and described herein. The method may include washing the coffee beans before immersing in the medium. The method may include sanitizing the coffee beans before immersing in the medium.

In some aspects, the techniques described herein relate to a post-harvest treatment of green coffee beans for roasting including: providing a predetermined volume of green coffee beans in a germination chamber; immersing said beans in said germination chamber with a liquid bath to define a first-hydrated medium; draining said first-hydrated medium and aerating said beans to define a first-hydrated bean population; immersing said first-hydrated bean population in said germination chamber with a liquid bath to define a second-hydrated medium; draining said second-hydrated medium and aerating said beans to define a second-hydrated bean population; immersing said second-hydrated bean population in said germination chamber with a liquid bath to define a third-hydrated medium; draining said third-hydrated medium and aerating said beans to define a third-hydrated bean population; and decanting said third-hydrated bean population to a layer of substantially uniform thickness and removing bean moisture to an internal residual moisture content between about 10% to about 12% moisture content by weight.

In some aspects, the techniques described herein relate to a method of short-term germination of a coffee bean species to reduce effects of anti-nutritive characteristics, including exposing a predetermined volume of coffee beans to a plurality of hydration, activation, and dehydration cycles to yield a short-term germinated coffee bean population having a reduction of anti-nutritive compounds and without adversely impacting organoleptic properties, and wherein each individual hydration cycle includes a time period less than a time required for conventional hydration for complete germination of said coffee bean species.

In some aspects, the techniques described herein relate to a method of preparing coffee beans for roasting including: providing a plurality of coffee beans in a substantially water impermeable container; adding a discrete hydration medium to said container; germinating said beans at a temperature of about 29° C. to about 31° C. for substantially two hours; discharging said medium and aerating said beans; subsequently germinating said beans at a temperature of about 29° C. to about 31° C. for substantially two hours; and subsequently discharging said medium and aerating said beans, and wherein said method consisting essentially of providing at least two discrete hydration and subsequent dehydration cycles.

In some aspects, the techniques described herein relate to a coffee bean treatment including hydrating a coffee bean at an amount and duration effective for improving a short term organoleptic germination characteristic of said bean; physically manipulating said beans; and providing single-direction, positive airflow ventilation about said beans.

In some aspects, the techniques described herein relate to a coffee bean treatment including penetrating said bean with a plurality of discrete mediums to substantially hydrate said beans for activating metabolism; providing a bean activation phase; and aerating said beans between said discrete medium penetrations.

In some aspects, the techniques described herein relate to a short-term germinated green coffee bean including an improved organoleptic characteristic treated by any of the methods herein.

In some aspects, the techniques described herein relate to a short-term germinated green coffee bean including a reduced antinutrient characteristic treated by any of the methods herein.

In some aspects, the techniques described herein relate to a coffee liquid including roasting products of a coffee bean population, wherein said coffee bean population including short term organoleptic germination characteristics derived from any of the methods herein.

In some aspects, the techniques described herein relate to a coffee liquid including roasting products of a coffee bean population, wherein said coffee bean population including short term reduced antinutrient characteristics derived from any of the methods herein.

In some aspects, the techniques described herein relate to a coffee liquid including roasting products of a coffee bean population, wherein said coffee bean population including reduced caffeine content derived from any of the methods herein.

In some aspects, the techniques described herein relate to a method of treatment of green coffee beans for roasting including: providing a predetermined volume of green coffee beans in a germination chamber; immersing said beans in said germination chamber with a liquid bath to define a first-hydrated medium; draining said first-hydrated medium and aerating said beans to define a first-hydrated bean population; immersing said first hydrated bean population in said germination chamber with a liquid bath to determine a second hydrated medium; draining said second-hydrated medium and aerating said beans to define a second-hydrated bean population; immersing said second hydrated bean population in said germination chamber with a liquid bath to define a third hydrated medium; draining said third-hydrated medium and aerating said beans to define a third-hydrated bean population; and decanting said third-hydrated bean population to a layer of substantially uniform thickness, left to activate for a period of about 16 hours or until an exothermic reaction is evident, and removing bean moisture to an internal residual moisture content between about 10% to about 12% moisture content by weight.

In the present disclosure, contemplated beans may include uniform density beans, that are unbroken, non-discolored, mold-free, pathogen free, with an inherent moisture level less than about 12.5% moisture content. Some embodiments herein include processing certified organic green coffee beans, and the like. Additionally, processed beans, and attendant steps, may be processed in a manner to reduce cross contamination from foreign species or agents. In some embodiments, the foreign species or agents comprise one or more of: mold, mold spores, bacterium, viruses, pathogens, gluten, or gluten derivatives. In some embodiments, processes or steps to reduce gluten content or gluten contamination may be carried out before germination. In some embodiments, gluten testing may be carried out on pre processed or post processed coffee seeds, to determine any gluten contamination. In some embodiments, the processes or steps to reduce gluten content or gluten contamination may comprise one or more of the following: working in a gluten free facility, minimizing contact with gluten containing products, or testing of processed products to determine gluten contamination.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s). The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A and FIG. 1B illustrates a small scale coffee seed population under conditions for germination.

FIG. 2 illustrates a population of coffee seeds washed with various sanitizing solutions.

### DETAILED DESCRIPTION

The detailed description set forth below in connection with the drawings is intended as a description of various configurations and is not intended to represent the only configurations in which the concepts described herein may be practiced. The detailed description include specific details for the purpose of providing a thorough understanding of various concepts. However, it will be apparent to those skilled in the art that these concepts may be practiced without these specific details.

Those skilled in the art having the benefit of this disclosure will recognize any coffee bean application, including different and blended varieties from differing species. In certain examples, bean selection includes the use of minimally processed green coffee beans, for instance which have been removed from the cherry, deskinned/de-pulped, hydrated, dehulled, and/or polished. Particular beans may include uniform density beans, that are unbroken, non-discolored, mold-free, pathogen free, with an inherent moisture level less than about 12.5% moisture content. Alternative embodiments include processing certified organic green coffee beans, and the like. The products of the inventions herein may be used in a variety of end use applications (including residential and commercial coffee products) to increase the bioavailability, and/or digestibility of active compounds, as well as exhibit a perceived improved coffee drinking experience. Overall, the products of the inventions herein provide a more pleasing and healthy coffee product, and the like. For instance, embodiments of products of the inventions herein enhance the sensory coffee drinking experience and/or reduce less-pleasing coffee drinking aspects, including, but not limited to, reduced caffeine content and/or improved organoleptic traits. Further, as shown and described herein, the processes and methods reduce any variety of anti-nutritive compounds, including, but not limited to, phytic acid and tannic acid. Those skilled in the art having the benefit of this disclosure will recognize additional anti-nutritive compounds, variations, and the like.

Moreover, Applicants have unexpectedly discovered the improved germination processes herein enhance the nutritional value of the coffee beans by modifying bean attributes, characteristics, and the like, including, but not limited to, breaking down macromolecules into lower molecular weight molecules that are generally more digestible and more rapidly absorbed by the consumer, as compared to conventional practices. Further unanticipated advantages of these improved processes include superior activation of enzymes in dormant beans to trigger various enzymatic activities, often leading to the breakdown of stored proteins, carbohydrates, and lipids into simpler forms. In addition, during these improved germination processes, Applicants have uniquely discovered the degradation of sugars, free amino acids, and organic acids is significantly reduced in the coffee beans as compared to traditional methodology. Related teachings include Katina, K. et al. (2007) J Cereal Sci 46:348; Dhaliwal, Y. S. & Aggarwal, R. A. K. (1999) J Food Sci Techno 36:26; Elkhalifa, A. E. O.; Bernhardt, R. Influence of grain germination on functional properties of sorghum flour. Food Chem. 121, 387-392; Gan, R.-Y.; Lui, W. Y.; Wu, K.; Chan, C.-L.; Dai, S.-H.; Sui, Z.-Q.; Corke, H. Bioactive compounds and 20 bioactivities of germinated edible beans and sprouts: An updated review. Trends Food Sci. Technol. 2017, 59, 1-14; and Metabolic Processes During Germination. Awatif S. et al. Pub Dec. 6, 2017 DOI: 10.5772/intecopen 70635, the teachings of which that are consistent with the embodiments and examples shown and described herein are incorporated by reference in their entireties.

In operation of one embodiment, a predetermined volume of green coffee beans, including any of the beans shown and described herein, is provided in a germination chamber, or the like; immersing the beans in the germination chamber with a liquid bath to define a first-hydrated medium, including, but not limited to a water, aqueous, or the like, medium; draining the first-hydrated medium and aerating the beans to define a first-hydrated bean population; immersing the first-hydrated bean population in the germination chamber with a liquid bath to define a second-hydrated medium, including, but not limited to a water, aqueous, or the like, medium; draining the second-hydrated medium and aerating the beans to define a second-hydrated bean population; immersing the second-hydrated bean population in the germination chamber with a liquid bath to define a third-hydrated medium, including, but not limited to a water, aqueous, or the like, medium; draining the third-hydrated medium and aerating the beans to define a third-hydrated bean population. Typically, the operation then includes decanting, or otherwise providing, a third-hydrated bean population to a layer of substantially uniform thickness, or the like; physically manipulating the beans, and reducing/removing bean moisture to an internal residual moisture content correlating to a targeted species' internal residual moisture content including but not limited to, between about 10% to about 12% moisture content by weight.

In operation of one embodiment, the method further comprises roasting processed beans having an internal residual moisture content between about 10% to about 12% moisture content by weight. In some embodiments, the roasting is carried out so the average internal temperature of the processed beans reaches between about 175 degrees Celsius to between about 210 degrees Celsius. In some embodiments, the roasting is carried out so the average internal temperature of the processed beans reaches between about 175 degrees Celsius to between about 255 degrees Celsius. In operation of one embodiment, the method further comprises grinding the roasted processed beans. In some embodiments, grinding is carried out by burrs.

In some embodiments, the method may include a green coffee seed or green coffee bean that has been sanitized. In some embodiments, the method may include washing the coffee beans before immersing in the medium. The method may include sanitizing the coffee beans before immersing in the medium. In some embodiments, the method may include sanitizing the coffee beans in a sodium hypochlorite solution prior to the germination process. In some embodiments, the method may include sanitizing the coffee beans in an organic acid solution prior to the germination process. In some embodiments, the method may include sanitizing the coffee beans in a peracetic acid (PAA) solution prior to the germination process.

In operation of one embodiment, coffee beans are hydrated and activated at an amount and duration effective for improving the organoleptic characteristic of the bean; physically manipulating the beans; and providing single-direction, positive airflow ventilation about the beans, and wherein the resulting coffee beans being a ready-to-roast bean population.

In operation of one embodiment, coffee beans are exposed to a plurality of hydration, activation, and dehydration cycles to yield a short-term germinated coffee bean population, typically having a reduction of anti-nutritive compounds and without adversely impacting organoleptic properties. Typically, each individual hydration cycle comprises a time period less than a time required for conventional hydration for complete germination of the coffee bean species.

All patents, applications, published applications and other publications referred to herein are incorporated herein by reference to the referenced material and in their entireties. If a term or phrase is used herein in a way that is contrary to or otherwise inconsistent with a definition set forth in the patents, applications, published applications and other publications that are herein incorporated by reference, the use herein prevails over the definition that is incorporated herein by reference.

All technical and scientific terms used herein have the same meaning as commonly understood to one of ordinary skill in the art to which this disclosure belongs unless clearly indicated otherwise.

As used herein, the singular forms “a”, “and”, and “the” include plural referents unless the context clearly dictates otherwise. Thus, for example, reference to “a sequence” may include a plurality of such sequences, and so forth.

The terms comprising, including, containing and various forms of these terms are synonymous with each other and are meant to be equally broad. Moreover, unless explicitly stated to the contrary, examples comprising, including, or having an element or a plurality of elements having a particular property may include additional elements, whether or not the additional elements have that property.

Aspects of the present disclosure relate generally to methods and systems for processing coffea seed, also known as coffee beans. In particular, in some embodiments, the present disclosure relates to methods and systems wherein coffee beans are germinated prior to roasting and grinding.

While operations may be depicted in the drawings or described in the specification in a particular order, such operations need not be performed in the particular order shown or in sequential order, or that all operations be performed, to achieve desirable results.

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” represent a value, amount, or characteristic close to the stated value, amount, or characteristic that still performs a desired function or achieves a desired result.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Although the foregoing invention has been described in terms of certain preferred embodiments, other embodiments will be apparent to those of ordinary skill in the art. Additionally, other combinations, omissions, substitutions and modification will be apparent to the skilled artisan, in view of the disclosure herein. Accordingly, the present invention is not intended to be limited by the recitation of the preferred embodiments, but is instead to be defined by reference to the appended claims. All references cited herein are incorporated by reference in their entirety.

The terminology used in the description presented herein is not intended to be interpreted in any limited or restrictive manner and unless otherwise indicated refers to the ordinary meaning as would be understood by one of ordinary skill in the art in view of the specification. Furthermore, embodiments may comprise, consist of, consist essentially of, several novel features, no single one of which is solely responsible for its desirable attributes or is believed to be essential to practicing the embodiments herein described. As used herein, the section headings are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings herein.

Although this disclosure is in the context of certain embodiments and examples, those of ordinary skill in the art will understand that the present disclosure extends beyond the specifically disclosed embodiments to other alternative embodiments and/or uses of the embodiments and obvious modifications and equivalents thereof. In addition, while several variations of the embodiments have been shown and described in detail, other modifications, which are within the scope of this disclosure, will be readily apparent to those of ordinary skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes or embodiments of the disclosure. Thus, it is intended that the scope of the present disclosure herein disclosed should not be limited by the particular disclosed embodiments described above.

### EXAMPLES

The following experiments demonstrate the efficacy and utility of the present disclosure.

### Experiment 1: Soak and Dehydration Test Screening

Activity in germination and dehydration was determined with moisture evaluation testing on coffee bean species. The moisture evaluation was observed at hour intervals.
Soak treatment observations are contained in Table 1 below.

TABLE 1
SOAK

| | 10 lb Sumatran Mandehling | | 10 lb Costa Rica La Minta | |
|---|---|---|---|---|
| | Split: | | | |
| | 5 lb | 5 lb | 5 lb | 5 lb |
| | Sumatran | Sumatran | Costa Rica | Costa Rica |
| | Protocol: | | | |
| | 2 hr Rinse | No Drain | 2 hr Rinse | No Drain |
| | Marker: | | | |
| | #3 Orange | #4 Black | #1 Red | #2 Brown |
| | Clip | Clip | Clip | Clip |
| Initial Soak | 10:30 | 10:30 | 10:30 | 10:30 |
| Room Temp | 25° C. | 25° C. | 25º C. | 25° C. |
| Room Humidity | 24% | 24% | 24% | 24% |
| Water Temp | 31.3° C. | 31.3° C. | 31.3° C. | 31.3° C. |
| 2 hr Drain | 12:30 | NA | 12:30 | NA |
| Bean Moisture % | 30.85% | 29.87% | 40.80% | 37.67% |
| Room Temp | 27º C. | 27° C. | 27° C. | 27º C. |
| Room Humidity | 22% | 22% | 22% | 22% |
| Water Temp | 32° C. | 26.1° C. | 31.3° C. | 26.1° C. |
| 2 hr Drain | 2:30 | NA | 2:30 | NA |
| Bean Moisture % | 39.04% | 40.56% | 47.23% | 46.74% |
| Room Temp | 27° C. | 27° C. | 27° C. | 27° C. |
| Room Humidity | 22% | 22% | 22% | 22% |
| Water Temp | 31.3° C. | 28.1° C. | 31.3° C. | 28.1º C. |
| Final Drain | 4:30 | 4:30 | 4:30 | 4:30 |
| Bean Moisture % | 41.75% | 49.74% | 49.27% | 49.43% |
| Room Temp | 28° C. | 28° C. | 28° C. | 28° C. |
| Room Humidity | 20% | 20% | 20% | 20% |
| Water Temp | 29.7° C. | 29.7° C. | 29.7° C. | 29.7º C. |

Dehydration treatment observations are contained in Table 2 below.

TABLE 2

| DEHYDRATION | | | | | Food Dehydrator | |
|---|---|---|---|---|---|---|
| | D1 | | | | (Tabletop) | |
| | 5 lb | 4 lb | 5 lb | 4 lb | 1 lb | 1 lb |
| | Sumatran | Sumatran | Costa Rica | Costa Rica | Sumatran | Costa Rica |
| Dryer Start Time: | 8:05 | 8:05 | 8:05 | 8:05 | | |
| Dryer Temp: | 140° | 140° | 140° | 140° | | |
| A.M. wet Bean Moisture: | 43.05% | 42.42% | 50.69% | 48.56% | | |
| A.M. Room Temp: | 28° C. | 28° C. | 28° C. | 28° C. | | |
| A.M. Room Humidity: | 22% | 22% | 22% | 22% | | |
| Check Time: | 9:30 | 9:30 | 9:30 | 9:30 | | |
| Moisture: | 15.24% | | 19.16% | | | |
| Check Time: | 10:00 | 10:00 | 10:00 | 10:00 | | |
| Moisture: | 11.96% | 12.66% | | | | |
| Check Time: | 10:08 | 10:08 | 10:08 | 10:08 | 11:00 | 11:00 |
| Moisture | | | 12.03% | 12.43% | 13.52% | 16.01% |
| Add more checks if needed | | | | | 11:20 | 11:20 |
| FP Moisture | | | | | 11:41% | 12.01% |

Observations of Experiment 1 included improved flavor and aromatic profiles of the green coffee beans after treatment under the cited conditions to be used as a primary ingredient for the production of coffee-based food products.

### Experiment 2: Soak and Dehydration Test Screening

Activity in germination and dehydration was determined with moisture evaluation testing on coffee beans. The moisture evaluation was observed at 2 hour intervals.
Soak treatment observations are contained in Table 3 below.

TABLE 3
SOAK

| | Samples: | | | |
|---|---|---|---|---|
| | 10 lb | 10 lb | 10 lb | 10 lb |
| | Brazilian | Brazilian | Sumatran | Sumatran |
| | (Vacuum | | (Vacuum | |
| | Packed) | | Packed) | |
| | Protocol: | | | |
| | 2 hr Rinse | No Drain | 2 hr Rinse | No Drain |
| | Marker: | | | |
| | Protocol 2 | Protocol 1 | Protocol 2 | Protocol 1 |
| Raw Bean Moisture | 10.55 | 11.5 | 11.76 | 11.17 |
| Initial Soak | 10:30 | 10:30 | 10:30 | 10:30 |
| Room Temp | 26° C. | 26° C. | 26° C. | 26° C. |
| Room Humidity | 45% | 45% | 45% | 45% |
| Water Temp | 30.46 | 31.14 | 32.22 | 31.66 |
| (31.6° C.) | | | | |
| 2 hr Drain | 12:30 | 12:30 | 12:30 | 12:30 |
| Bean Moisture % | 41.75% | 40.42% | 32.44% | 31.17% |
| Room Temp | 28° C. | 28° C. | 28° C. | 28° C. |
| Room Humidity | 37% | 37% | 37% | 37% |
| Water Temp | 28.41 | 29.42 | 31.89 | 29.93 |
| pH | 7.2 | 7.1 | 8.1 | 8 |
| (water pH-8) | | | | |
| 2 hr Drain | 14:30 | 14:30 | 14:30 | 14:30 |
| Bean Moisture % | 48.74% | 51.58% | 42.07% | 34.39% |
| Room Temp | 28° C. | 28° C. | 28° C. | 28° C. |
| Room Humidity | 30% | 30% | 30% | 30% |
| Water Temp | 30.49 | 29.41 | 31.32 | 28.94 |
| pH | 7.9 | 7.9 | 8.1 | 8 |
| 2 hr Drain | 16:30 | 16:30 | 16:30 | 16:30 |
| Bean Moisture % | 50.48% | 52.83% | 46.80% | 48.97% |
| Room Temp | 28° C. | 28° C. | 28° C. | 28° C. |
| Room Humidity | 27% | 27% | 27% | 27% |
| Water Temp | 29.54 | 28.96 | 32.04 | 28.6 |
| pH | 7.8 | 7.2 | 7.9 | 7.5 |

Dehydration treatment observations are contained in Table 4 below.

TABLE 4

| | DEHYDRATION | | | |
|---|---|---|---|---|
| | D1 | | | |
| | 10 lb | 10 lb | 10 lb | 10 lb |
| | Brazilian | Brazilian | Sumatran | Sumatran |
| Dryer Start Time: | 8:00 | | | |
| Dryer Temp: | 140° F. | 140° F. | 140° F. | 140° F. |
| A.M. wet Bean Moisture: | 50.16% | 49.80% | 43.80% | 40.56% |
| A.M. Room Temp: | 29° C. | 29° C. | 29° C. | 29° C. |
| A.M. Room Humidity: | 16% | 16% | 16% | 16% |
| Check Time: | | | 9:15 | 9:15 |
| Moisture: | | | 23.77% | 16.88% |
| Check Time: | | | | 9:45 |
| Moisture: | | | | 12.54% |
| Check Time: | | 10:00 | 10:00 | 10:00 |
| Moisture: | | 14.04% | 15.56% | 11.80% |
| Check Time: | 10:13 | 10:13 | | |
| Moisture: | 12.21% | 11.59% | | |
| Check Time: | 10:20 | | 10:20 | |
| Moisture: | 11.52% | | 13.28% | |
| | | | Drying | |
| | | | for 10 min | |
| | | | (10:45-10:55) | |
| Check Time: | | | 10:55 | |
| Moisture: | | | 11.92% | |
| FP Moisture: | 11.52% | 11.59% | 11.92% | 11.80% |
| (10.5-12.0%) | | | | |

Observations of Experiment 2 included improved flavor and aromatic profiles of the green coffee beans after treatment under the cited conditions to be used as a primary ingredient for the production of coffee-based food products.

### Experiment 3: Soak and Dehydration Test Screening

Activity in germination and dehydration was determined with moisture evaluation testing on coffee beans. The moisture evaluation was observed at 2 hour intervals.
Soak treatment observations are contained in Table 5 below.

TABLE 5
SOAK

| | Samples: | |
|---|---|---|
| | 9.5 lb EL Indio | 9.5 lb EL Indio |
| | Lot # GF19956 (both bags) | |
| | Protocol: | |
| | No Rinse | 2 hr Rinse |
| | Marker: | |
| | Protocol 1 | Protocol 2 |
| Raw Bean Moisture | 10.86 | 10.86 |
| Initial Soak | 10:30 | 10:30 |
| Room Temp | 20° C. | 20° C. |
| Room Humidity | 41% | 41% |
| Water Temp (31.6° C.) | 31.6 C. | 31.1 C. |
| | (not rinsed, only measured) | |
| 2 hr Drain | 12:30 | 12:30 |
| Bean Moisture % | 44.44% | 48.34% |
| Room Temp | 25° C. | 25° C. |
| Room Humidity | 37% | 37% |
| Water Temp | 31.3 C. | 30.3 C. |
| 2 hr Drain | 2:30 pm | 2:30 pm |
| Bean Moisture % | 51.75% | 53.14% |
| Room Temp | 25° C. | 25° C. |
| Room Humidity | 35% | 35% |
| Water Temp | 28.7 C. | 32.2 C. |
| Final Drain | 4:30 pm | 4:30 pm |
| Bean Moisture % | 51.50% | 53.80% |
| Room Temp | 27° C. | 27° C. |
| Room Humidity | 34% | 34% |
| Water Temp | 29.4 C. | 30.1 C. |

Dehydration treatment observations are contained in Table 6 below.

TABLE 6
DEHYDRATION

| | D1 | |
|---|---|---|
| | 9.5 lb EL Indio | 9.5 lb EL Indio |
| | No Rinse PTCL 1 | Rinse PTCL 2 |
| Dryer Start Time: | 10:20 am | 10:20 am |
| Dryer Temp: | 130° F. | 130° F. |
| A.M. wet Bean Moisture: | 54.59% | 55.38% |
| A.M. Room Temp: | 29° C. | 29° C. |
| A.M. Room Humidity: | 24% | 24% |
| Check Time: | 11:20 am | 11:20 am |
| Moisture: | 29.97% | 31.94% |
| Check Time: | 12:30 pm | 12:30 pm |
| Moisture: | 22.77% | 18.36% |
| Check Time: | 1:15 pm | 1:15 pm |
| Moisture: | 16.02% | 18.03% |
| Check Time: | 1:50 pm | 1:50 pm |
| Moisture: | 11.82% | 10.97% |

Observations of Experiment 3 included improved flavor and aromatic profiles of the green coffee beans after treatment under the cited conditions to be used as a primary ingredient for the production of coffee-based food products.

### Experiment 4: Caffeine Content Test Screening

Caffeine content in coffee beans germinated via the methodology shown and described herein during Experiment 3 are contained in Table 7 below.

TABLE 7

| | | | | | Test Unit cfu/g OR ml | |
|---|---|---|---|---|---|---|
| | Gelda | Customer supplied data* | | | OR Swab OR as Slated | |
| | Code | | No. of | Sample | | Caffein |
| Seq# | (xxx) | Sample Description | Comp. | Matrix | | HPLC-HV |
| 1 | 1 | Raw Green Coffee | 1 | Food | | 1.18 |
| | | (control) | | | | |
| 2 | 2 | Sprouted Green Coffee | 1 | Food | | 0.99 |
| | | P1 (1020R0) | | | | |
| 3 | 3 | Sprouted Green Coffee | 1 | Food | | 0.89 |
| | | (P2 (1020R3) | | | | |

### Experiment 5: Commercial Scale Test Screening

Activity in scaled-up commercial size germination and dehydration was determined with moisture evaluation testing on coffee beans.

First, 1000 pounds of La Minita (Costa Rica) green coffee bean variety with a starting moisture level of 9.0% was loaded into a germination apparatus and filed with a pre-tempered water. The water was at a temperature between 29° C.-31° C. and the beans were fully immersed. The environmental conditions for germination were between 25° C.-35° C. with a 40-60% humidity.

The initial soak was drained from the beans and the beans were rinsed and agitated/aerated. The germination apparatus was then refilled. A first appearance of the rinse water was that the water was darkening with a noticeable coffee aroma. Then, the water bath was drained from the beans, the beans were rinsed and aerated. The germination apparatus was then refilled. A second appearance of the rinse water was that the water was darkening with a slightly sticky feel. Several suspensor roots among the beans were noted.

Then, the final water bath was drained from the beans, the beans were positioned for germination. The appearance of the rinse water following the final drain was lighter when compared to previous colorations, and the beans provided a stickier residue, as compared to previous residues. Additional suspensor roots were noted among the beans. A germination apparatus provided agitation and aeration through the night to provide a desired exothermic reaction. The beans were germinated for sixteen (16) hours with steady environmental conditions. The beans were then transferred to steel trays and placed in a dehydration unit. The temperature during dehydration was less than 125 degrees Fahrenheit.

Observations of Experiment 4 and 5 included improved flavor and aromatic profiles of the green coffee beans after treatment under the cited conditions to be used as a primary ingredient for the production of coffee-based food products.

### Experiment 6

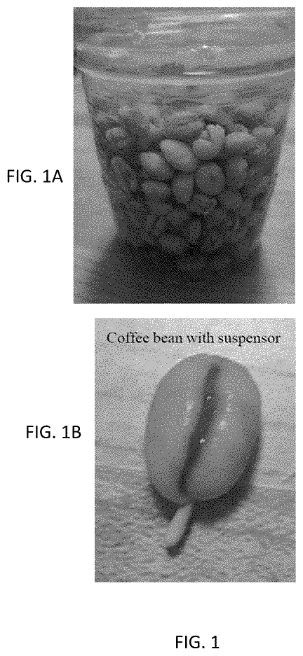

Coffea seeds (coffee beans) were soaked in a glass jar, submerged, in warm water to determine overall germination timepoints. FIG. 1A depicts the bean population submerged in the jar.

The protocol proceeded as follows:
1. 100 g Tazmanian peaberry coffee beans were soaked in a glass jar, submerged in warm water.
2. Beans were soaked, rinsed, and the jar refilled after 2 hours, repeated twice for a total of a 6 hour soak.
3. Beans were held for 18 hours, and then spread evenly on a sheet and dried in an oven set to a minimum of 37 degrees centigrade. The sheet was removed and the beans were rotated by shaking every 15 minutes.

Suspensor sprouts were observed protruding from seeds at the end of 6 hours (FIG. 1B). Increased organoleptic properties were observed, as a coffee beverage based on the beans was less bitter.

### Experiment 7

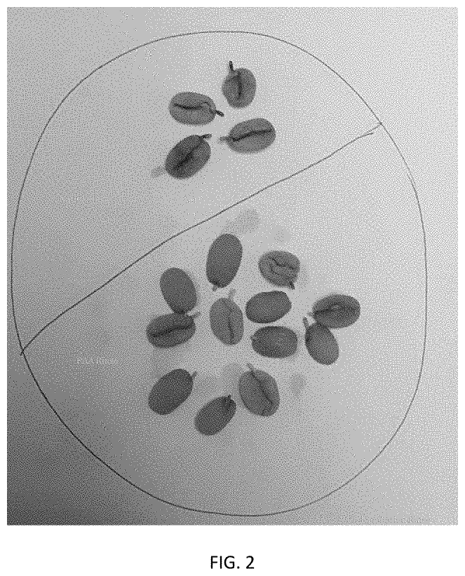

Coffea seeds (coffee beans) were treated to seed sanitization rinses using either Sodium hypochlorite or Peracetic acid (PAA) prior to germination (See FIG. 2). FIG. 2 depicts that using either sodium hypochlorite or peracetic acid prior to germination still allowed seed germination to initiate due to the presence of the emerged suspensor structure.

### Experiment 8

Coffee seeds were compared between control green coffee, and green coffee seeds which had begun germination and partially or fully sprouted. Table 1 describes how green coffee, had a caffeine percentage of 1.18 as measured by HPLC (High Performance Liquid Chromatography), while replicates of a germinated coffee population had caffeine levels measurably lower, at 0.99 and 0.89 caffeine % respectively.

TABLE 1

| Sample | Caffeine % (HPLC-HV) |
|---|---|
| Raw Green Coffee (Control) | 1.18 |
| Sprouted Green Coffee (P1) (1020R0) | 0.99 |
| Sprouted Green Coffee (P2) (1020R3) | 0.89 |

As illustrated above, enhanced moisture content in the various coffee beans performed well, as they exhibited accelerated short-term germination enhancements to reduce effects of anti-nutritive characteristics. Further, the methods and processes herein illustrated in the various Tables yielded short-term germinated coffee bean populations having a reduction of caffeine content without adversely impacting organoleptic properties. Using methods and systems as described herein, Applicant believes the post-harvest treatment of crops, including coffee beans, will be improved. Further, Applicant believes that using methods and systems described herein will improve caffeine content of resulting coffee drinks, semi-solid coffee products, solid coffee products, and the like, while improving any of the organoleptic properties shown and described herein or recognized by one skilled in the art having the benefit of this disclosure.

Numerous characteristics and advantages have been set forth in the foregoing description, together with details of structure and function. Many of the novel features are pointed out in the appended claims. The disclosure, however, is illustrative only, and changes may be made in detail, especially in matters of shape, size, and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range.

In some aspects, the techniques described herein relate to a post-harvest treatment of green coffee beans for roasting including: providing a predetermined volume of green coffee beans in a germination chamber; immersing said beans in said germination chamber with a liquid bath to define a first-hydrated medium; draining said first-hydrated medium and aerating said beans to define a first-hydrated bean population; immersing said first-hydrated bean population in said germination chamber with a liquid bath to define a second-hydrated medium; draining said second-hydrated medium and aerating said beans to define a second-hydrated bean population; immersing said second-hydrated bean population in said germination chamber with a liquid bath to define a third-hydrated medium; draining said third-hydrated medium and aerating said beans to define a third-hydrated bean population; and decanting said third-hydrated bean population to a layer of substantially uniform thickness and removing bean moisture to an internal residual moisture content between about 10% to about 12% moisture content by weight.

In some aspects, the techniques described herein relate to a method wherein said coffee beans absorb said first-hydrated medium to a range of about 28% to about 45% moisture content by weight.

In some aspects, the techniques described herein relate to a method, wherein a Sumatran Mandehling coffee bean absorbs said first-hydrated medium to a range of about 29% to about 33% moisture content by weight.

In some aspects, the techniques described herein relate to a method, wherein a Costa Rican coffee bean absorbs said first-hydrated medium to a range of about 37% to about 41% moisture content by weight.

In some aspects, the techniques described herein relate to a method, wherein a Brazilian coffee bean absorbs said first-hydrated medium to a range of about 40% to about 42% moisture content by weight.

In some aspects, the techniques described herein relate to a method, wherein a Sumatran Mandehling coffee bean absorbs said second-hydrated medium to a range of about 39% to about 41% moisture content by weight.

In some aspects, the techniques described herein relate to a method, wherein a Costa Rican coffee bean absorbs said second-hydrated medium to a range of about 46% to about 48% moisture content by weight.

In some aspects, the techniques described herein relate to a method, wherein a Brazilian coffee bean absorbs said second-hydrated medium to a range of about 48% to about 52% moisture content by weight.

In some aspects, the techniques described herein relate to a method, wherein a Sumatran Mandehling coffee bean absorbs said third-hydrated medium to a range of about 40% to about 50% moisture content by weight.

In some aspects, the techniques described herein relate to a method, wherein a Costa Rican coffee bean absorbs said third-hydrated medium to a range of about 49% to about 50% moisture content by weight.

In some aspects, the techniques described herein relate to a method, wherein a Brazilian coffee bean absorbs said third-hydrated medium to a range of about 50% to about 53% moisture content by weight.

In some aspects, the techniques described herein relate to a method, wherein immersing said beans in said liquid bath includes immersing in a water bath.

In some aspects, the techniques described herein relate to a method, including passing said water bath through a filter adapted to remove particulate contaminants.

In some aspects, the techniques described herein relate to a method, wherein said filter including a charcoal filter.

In some aspects, the techniques described herein relate to a method, including treating said water bath with an ultraviolet light treatment.

In some aspects, the techniques described herein relate to a method, including selecting a green coffee bean removed from a cherry and having a uniform density.

In some aspects, the techniques described herein relate to a method, including maintaining an environmental temperature of about 25° C. to about 35° C.

In some aspects, the techniques described herein relate to a method, including maintaining an environmental temperature of about 29° C. to about 32° C.

In some aspects, the techniques described herein relate to a method, including activating a plurality of thermostatic mixing valves adapted to maintain a constant outlet temperature into said germination chamber.

In some aspects, the techniques described herein relate to a method, including monitoring temperature deviations.

In some aspects, the techniques described herein relate to a method, including sensing and correcting temperature deviations.

In some aspects, the techniques described herein relate to a method, including maintaining an environmental humidity of less than about 75% humidity.

In some aspects, the techniques described herein relate to a method, including maintaining an environmental humidity of between about 40% to about 60% humidity.

In some aspects, the techniques described herein relate to a method, including sensing and correcting environmental humidity.

In some aspects, the techniques described herein relate to a method, including providing a negative air pressure germination environment.

In some aspects, the techniques described herein relate to a method, including filtering a selection chosen from the group consisting of fine particulates, airborne contaminants, a combination thereof, and the like.

In some aspects, the techniques described herein relate to a method, including treating said air with an ultraviolet light treatment.

In some aspects, the techniques described herein relate to a method, wherein providing said predetermined volume of green coffee beans includes decanting said beans into a germination chamber.

In some aspects, the techniques described herein relate to a method, including monitoring liquid bath absorption rates.

In some aspects, the techniques described herein relate to a method, including variating liquid bath absorption rates adapted for specific bean species.

In some aspects, the techniques described herein relate to a method, including monitoring absorption rates with a halogen moisture analyzer.

In some aspects, the techniques described herein relate to a method, wherein aerating said beans includes circulating oxygen about said germination chamber.

In some aspects, the techniques described herein relate to a method, including agitating said beans.

In some aspects, the techniques described herein relate to a method, including agitating said beans at a rate between about five to about twenty-five rotations per minute.

In some aspects, the techniques described herein relate to a method, including agitating said beans for a time period between about two minutes to about five minutes.

In some aspects, the techniques described herein relate to a method, wherein decanting to said substantially uniform thickness includes transferring said third-hydrated bean population to a growing tray.

In some aspects, the techniques described herein relate to a method, including aligning said third-hydrated bean population to a predetermined thickness adapted for a respire environment.

In some aspects, the techniques described herein relate to a method, including aligning said third-hydrated bean population to a thickness of about three inches to about eight inches adapted for a specific respire environment.

In some aspects, the techniques described herein relate to a method, maintaining a minimum thickness adapted for a predetermined exothermic energy release environment.

In some aspects, the techniques described herein relate to a method, wherein said predetermined exothermic energy release being achieved when a core temperature of said bean reaching about a one hundred degree Fahrenheit temperature.

In some aspects, the techniques described herein relate to a method, wherein said one hundred degree Fahrenheit temperature triggering an energy release and chemical change indicative of phase two of bean germination.

In some aspects, the techniques described herein relate to a method, wherein said slowing of said germination being subsequently triggered through said dehydration.

In some aspects, the techniques described herein relate to a method, including dehydrating at a predetermined dehydration temperature.

In some aspects, the techniques described herein relate to a method, including dehydrating at a dehydration temperature of about 120° Fahrenheit to about 140° Fahrenheit.

In some aspects, the techniques described herein relate to a method, including dehydrating for a predetermined time period.

In some aspects, the techniques described herein relate to a method, including dehydrating for a period of about four hours to about eight hours.

In some aspects, the techniques described herein relate to a method, including providing a single-direction, positive airflow ventilation about said beans.

In some aspects, the techniques described herein relate to a method, wherein said airflow includes about 2.000 cubic feet per minute to about 40.000 cubic feet per minute.

In some aspects, the techniques described herein relate to a method, wherein said airflow includes about 3.000 cubic feet per minute.

In some aspects, the techniques described herein relate to a method, including agitating said beans.

In some aspects, the techniques described herein relate to a method, including periodically agitating said beans between about two to about four hour intervals.

In some aspects, the techniques described herein relate to a method, including applying an effective amount of a composition.

In some aspects, the techniques described herein relate to a method, including washing said coffee beans before immersing in said medium.

In some aspects, the techniques described herein relate to a method, including sanitizing said coffee beans before immersing in said medium.

In some aspects, the techniques described herein relate to a method, including microbial reduction about said coffee beans.

In some aspects, the techniques described herein relate to a method, including producing a reduced caffeine content of said coffee bean.

In some aspects, the techniques described herein relate to a green coffee bean treated by the method.

In some aspects, the techniques described herein relate to a method of short-term germination of a coffee bean species to reduce effects of anti-nutritive characteristics, including exposing a predetermined volume of coffee beans to a plurality of hydration, activation, and dehydration cycles to yield a short-term germinated coffee bean population having a reduction of anti-nutritive compounds and without adversely impacting organoleptic properties, and wherein each individual hydration cycle includes a time period less than a time required for conventional hydration for complete germination of said coffee bean species.

In some aspects, the techniques described herein relate to a method of preparing coffee beans for roasting including: providing a plurality of coffee beans in a substantially water impermeable container; adding a discrete hydration medium to said container; germinating said beans at a temperature of about 29° C. to about 31° C. for substantially two hours; discharging said medium and aerating said beans; subsequently germinating said beans at a temperature of about 29° C. to about 31° C. for substantially two hours; and subsequently discharging said medium and aerating said beans, and wherein said method consisting essentially of providing at least two discrete hydration and subsequent dehydration cycles.

In some aspects, the techniques described herein relate to a coffee bean treatment including hydrating a coffee bean at an amount and duration effective for improving a short term organoleptic germination characteristic of said bean; physically manipulating said beans; and providing single-direction, positive airflow ventilation about said beans.

In some aspects, the techniques described herein relate to a method, wherein said resulting coffee beans being a ready-to-roast bean population.

In some aspects, the techniques described herein relate to a coffee bean treatment including penetrating said bean with a plurality of discrete mediums to substantially hydrate said beans for activating metabolism; providing a bean activation phase; and aerating said beans between said discrete medium penetrations.

In some aspects, the techniques described herein relate to a method, wherein said resulting coffee beans germinated under controlled environmental conditions.

In some aspects, the techniques described herein relate to a method, wherein said resulting coffee beans being adapted to include a reduced anti-nutritive yield compared to a control bean.

In some aspects, the techniques described herein relate to a short-term germinated green coffee bean including an improved organoleptic characteristic treated by any of the methods herein.

In some aspects, the techniques described herein relate to a short-term germinated green coffee bean including a reduced antinutrient characteristic treated by any of the methods herein.

In some aspects, the techniques described herein relate to a coffee liquid including roasting products of a coffee bean population, wherein said coffee bean population including short term organoleptic germination characteristics derived from any of the methods herein.

In some aspects, the techniques described herein relate to a coffee liquid including roasting products of a coffee bean population, wherein said coffee bean population including short term reduced antinutrient characteristics derived from any of the methods herein.

In some aspects, the techniques described herein relate to a coffee liquid including roasting products of a coffee bean population, wherein said coffee bean population including reduced caffeine content derived from any of the methods herein.

In some aspects, the techniques described herein relate to a method of treatment of green coffee beans for roasting including: providing a predetermined volume of green coffee beans in a germination chamber; immersing said beans in said germination chamber with a liquid bath to define a first-hydrated medium; draining said first-hydrated medium and aerating said beans to define a first-hydrated bean population; immersing said first hydrated bean population in said germination chamber with a liquid bath to determine a second hydrated medium; draining said second-hydrated medium and aerating said beans to define a second-hydrated bean population; immersing said second hydrated bean population in said germination chamber with a liquid bath to define a third hydrated medium; draining said third-hydrated medium and aerating said beans to define a third-hydrated bean population; and decanting said third-hydrated bean population to a layer of substantially uniform thickness, left to activate for a period of about 16 hours or until an exothermic reaction is evident, and removing bean moisture to an internal residual moisture content between about 10% to about 12% moisture content by weight.

In some aspects, the techniques described herein relate to a coffee bean population, including coffee beans treated using the method.

What is claimed is:

1. A post-harvest treatment of green coffee beans for roasting comprising:
providing a predetermined volume of green coffee beans in a germination chamber;
immersing said beans in said germination chamber with a liquid bath to define a first-hydrated medium;
draining said first-hydrated medium and aerating said beans to define a first-hydrated bean population;
immersing said first-hydrated bean population in said germination chamber with a liquid bath to define a second-hydrated medium;
draining said second-hydrated medium and aerating said beans to define a second-hydrated bean population;
immersing said second-hydrated bean population in said germination chamber with a liquid bath to define a third-hydrated medium;
draining said third-hydrated medium and aerating said beans to define a third-hydrated bean population; and
decanting said third-hydrated bean population to a layer of substantially uniform thickness and removing bean moisture to an internal residual moisture content between about 10% to about 12% moisture content by weight.

2. The method of claim 1 wherein said coffee beans absorb said first-hydrated medium to a range of about 28% to about 45% moisture content by weight.

3. The method of claim 2, wherein a Sumatran Mandehling coffee bean absorbs said first-hydrated medium to a range of about 29% to about 33% moisture content by weight.

4. The method of claim 2, wherein a Costa Rican coffee bean absorbs said first-hydrated medium to a range of about 37% to about 41% moisture content by weight.

5. The method of claim 2, wherein a Brazilian coffee bean absorbs said first-hydrated medium to a range of about 40% to about 42% moisture content by weight.

6. The method of claim 1, wherein a Sumatran Mandehling coffee bean absorbs said second-hydrated medium to a range of about 39% to about 41% moisture content by weight.

7. The method of claim 1, wherein a Costa Rican coffee bean absorbs said second-hydrated medium to a range of about 46% to about 48% moisture content by weight.

8. The method of claim 1, wherein a Brazilian coffee bean absorbs said second-hydrated medium to a range of about 48% to about 52% moisture content by weight.

9. The method of claim 1, wherein a Sumatran Mandehling coffee bean absorbs said third-hydrated medium to a range of about 40% to about 50% moisture content by weight.

10. The method of claim 1, wherein a Costa Rican coffee bean absorbs said third-hydrated medium to a range of about 49% to about 50% moisture content by weight.

11. The method of claim 1, wherein a Brazilian coffee bean absorbs said third-hydrated medium to a range of about 50% to about 53% moisture content by weight.

12. The method of claim 1, wherein immersing said beans in said liquid bath comprises immersing in a water bath.

13. The method of claim 12, including passing said water bath through a filter adapted to remove particulate contaminants.

14. The method of claim 13, wherein said filter comprising a charcoal filter.

15. The method of claim 13, including treating said water bath with an ultraviolet light treatment.

16. The method of claim 1, including selecting a green coffee bean removed from a cherry and having a uniform density.

17. The method of claim 1, including maintaining an environmental temperature of about 25° C. to about 35° C.

18. The method of claim 17, including maintaining an environmental temperature of about 29° C. to about 32° C.

19. The method of claim 17, including activating a plurality of thermostatic mixing valves adapted to maintain a constant outlet temperature into said germination chamber.

20. The method of claim 17, including monitoring temperature deviations.
